(19) United States
(12) Patent Application Publication
(10) Pub. No.: US 2019/0294078 A1
(43) Pub. Date: Sep. 26, 2019

(54) DEVELOPER CONTAINER, IMAGE FORMING UNIT, AND IMAGE FORMING APPARATUS

(71) Applicant: Oki Data Corporation, Tokyo (JP)

(72) Inventors: Masashi FUJII, Tokyo (JP); Junichi USHIKUBO, Tokyo (JP)

(21) Appl. No.: 16/287,481

(22) Filed: Feb. 27, 2019

(30) Foreign Application Priority Data
Mar. 23, 2018 (JP) 2018-056717

(51) Int. Cl. G03G 15/08; G03G 21/16

(52) U.S. Cl. CPC G03G 15/0875; G03G 21/1647; G03G 15/0886

(57) ABSTRACT

A developer container includes: a body in which a plurality of developer chambers that store developer are arranged, each developer chamber having an opening; and a plurality of covers that seal the openings of the plurality of developer chambers, the plurality of covers being separately provided to correspond to the openings of the plurality of developer chambers.

### BACKGROUND OF THE INVENTION

### 1. Field of the Invention

The present invention relates to a developer container that stores developer an image forming unit, and an image forming apparatus.

### 2. Description of the Related Art

A conventional developer container includes multiple developer chambers that are filled with developers of different colors and closed by a single cover (see e.g., Japanese Patent Application Publication. No. 2017-203940).

However, in the conventional technique, since multiple developer chambers are closed by a single cover, when the developer chambers are filled with developers of different colors, it is not possible to check for developer leakage from each developer chamber. Thus, mixture of developers of different colors in different developer chambers may occur, degrading image quality.

### SUMMARY OF THE INVENTION

An object of an aspect of the present invention is to make it possible to easily check for developer leakage from developer chambers.

According to an aspect of the present invention, there is provided a developer container including: a body in which a plurality of developer chambers that store developer are arranged, each developer chamber having an opening; and a plurality of covers that seal the openings of the plurality of developer chambers, the plurality of covers being separately provided to correspond to the openings of the plurality of developer chambers.

### BRIEF DESCRIPTION OF THE DRAWINGS

In the attached drawings:

FIG. 1 is an external perspective view of an image forming unit of an embodiment;

FIG. 2 is a side sectional view schematically illustrating a configuration of an image forming apparatus of the embodiment;

FIG. 3 is an external perspective view of a toner cartridge of the embodiment;

FIG. 4 is another external perspective view of the toner cartridge of the embodiment;

FIG. 5 is a sectional view of the toner cartridge of the embodiment;

FIG. 6 is a perspective view of the toner cartridge of the embodiment;

FIG. 7 is a perspective view of a stage of the embodiment;

FIG. 8 is a view for explaining the stage and rails of the embodiment;

FIGS. 9A and 9B are explanatory views illustrating a positional relationship between the rails and posts in the embodiment;

FIG. 10 is a side view of the toner cartridge of the embodiment;

FIG. 11 is a view for explaining limiters of the stage of the embodiment;

FIG. 12 is a perspective view of a shutter of the toner cartridge of the embodiment;

FIGS. 13A-13C are views for explaining engagement between the shutter and the stage in the embodiment;

FIGS. 14A and 14B are views for explaining a position where the toner cartridge begins to engage with the stage in the embodiment;

FIGS. 15A-15C are views for explaining openings of the toner cartridge of the embodiment;

FIGS. 16A-16C are views for explaining a position where the shutter begins engagement in the embodiment;

FIGS. 17A-17C are views for explaining an attachment position of the toner cartridge in the embodiment;

FIG. 18 is an exploded perspective view of the toner cartridge of the embodiment;

FIG. 19 is another exploded perspective view of the toner cartridge of the embodiment;

FIGS. 20A and 20B are views for explaining covers of the embodiment;

FIG. 21 is a side view of the toner cartridge of the embodiment;

FIG. 22 is a sectional view of the toner cartridge of the embodiment before the covers are attached;

FIGS. 23A and 23B are sectional views of the toner cartridge of the embodiment after two of the covers have been attached;

FIG. 24 is a sectional view of the toner cartridge of the embodiment after all the covers have been attached;

FIGS. 25A and 25B are views for explaining a toner cartridge of a comparative example;

FIG. 26 is a sectional view of the toner cartridge of the comparative example before a cover is attached; and

FIG. 27 is a sectional view of the toner cartridge of the comparative example after the cover has been attached.

### DETAILED DESCRIPTION OF THE INVENTION

A developer container, an image forming unit, and an image forming apparatus according to an embodiment of the present invention will now be described with reference to the drawings.

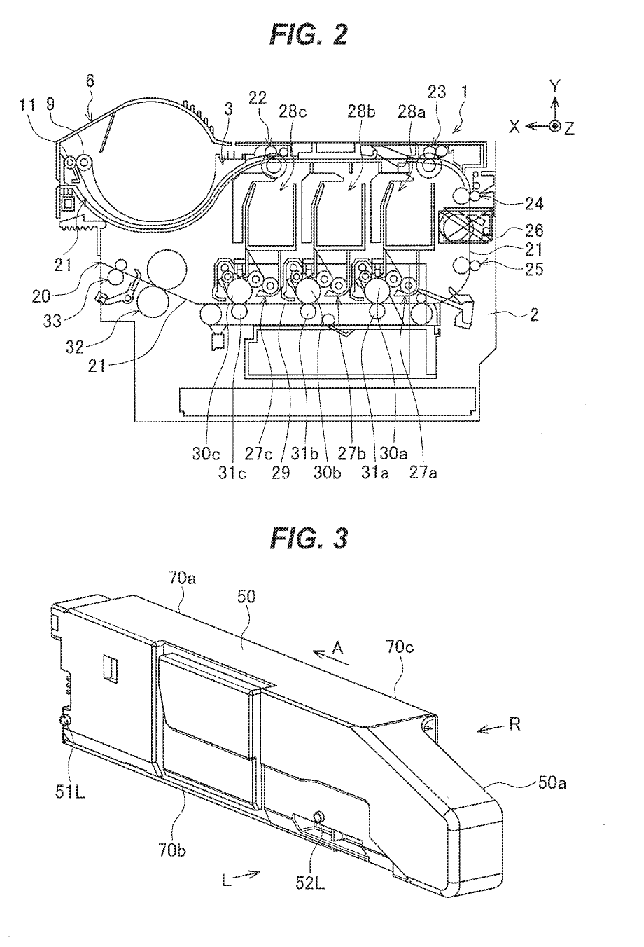

FIG. 2 is a side sectional view schematically illustrating a configuration of an image forming apparatus 1 according to an embodiment.

In FIG. 2, the image forming apparatus 1 is, for example, a roll paper printer with an image forming unit using an electrophotographic method, and includes a substantially box-shaped housing 2. It is assumed that a surface of the housing 2 on the left side of the drawing sheet is a front surface, a surface of the housing 2 on the right side of the drawing sheet is a back surface, a direction (indicated by arrow X in the drawing) from the back surface to the front surface of the housing 2 is the forward direction, a direction from the front surface to the back surface is the backward direction, a direction (indicated by arrow Y in the drawing) from the lower side to the upper side of the housing 2 is the upward direction, a direction from the upper side to the lower side is the downward direction, a direction of the housing 2 from the front side to the back side of the drawing sheet is the leftward direction, and a direction (indicated by arrow 2 in the drawing) of the housing 2 from the back side to the front side of the drawing sheet is the rightward direction.

A paper roll holder 3 that holds a cylindrical paper roll is disposed on the front side of an upper portion of the housing 2.

A cover 6 that covers the paper roll holder 3 is attached to the front side of the upper portion of the housing 2.

The image forming apparatus 1 is configured so that the cylindrical paper roll is stored in a cylindrical space consisting of a storage space of the paper roll holder 3 and an inner space of the cover 6 closed.

The paper roll holder 3 is provided with a holder side conveying roller 9, at an upper portion of a front end of the storage space. The cover 6 is provided with a cover side conveying roller 11. The cover side conveying roller 11 is configured so that when the cover 6 is closed, the cover side conveying roller 11 abuts the holder side conveying roller 9 and can convey paper (or a paper sheet) from the paper roll while nipping the paper.

A conveying path 21 is provided in the housing 2 of the image forming apparatus 1. The conveying path 21 extends from a front end of the paper roll holder 3 to a back end of the paper roll holder 3 along the lower side of the paper roll holder 3 and further extends through pairs of conveying rollers 22, 23, 24, 25, and 33 to a paper outlet 20.

The conveying path 21 is a path for conveying the paper from the paper roll stored in the paper roil holder 3 to the paper outlet 20, with the paper roll holder 3 side as the upstream side and the paper outlet 20 side as the downstream side.

The pairs of conveying rollers 72, 23, 24, 25, and 33 are pairs of rollers that nip and convey the paper from the paper roll. The pairs of conveying rollers 22, 23, 24, 25, and 33 are arranged in this order from the upstream side of the conveying path 21.

A housing side cutter 26 that cuts the paper is disposed between the pairs of conveying rollers 24 and 25.

Image forming portions 27a, 27b, and 27c are arranged along the conveying path 21 between the pairs of conveying rollers 25 and 33. The image forming portions 27a, 27b, and 27c may be referred to simply as the image forming portions 27.

The image forming portions 27a, 27b, and 27c form toner images as developer images of different colors (e.g., three colors). The image forming portions 27a, 27b, and 27c are arranged in this order from the upstream side of the conveying path 21. The image forming portions 27a, 27b, and 27c are attached with toner storing portions 28a, 28b, and 28c that store their respective toners.

A transfer belt 29 and transfer rollers 31a, 32b, and 31c are disposed below the image forming portions 27a, 27b, and 27c. The transfer belt 29 is annular and extends along the conveying path 21 in the front-back direction.

The transfer rollers 31a, 31b, and 31c are arranged to respectively face photosensitive drums 30a, 30b, and 30c of the image forming portions 27a, 27b, and 27c with the transfer belt 23 therebetween.

A fixing unit 32 is disposed downstream of the transfer belt 29 in the conveying path 21. The pair of conveying rollers 33 is disposed downstream of the fixing unit 32 and near the paper outlet 20.

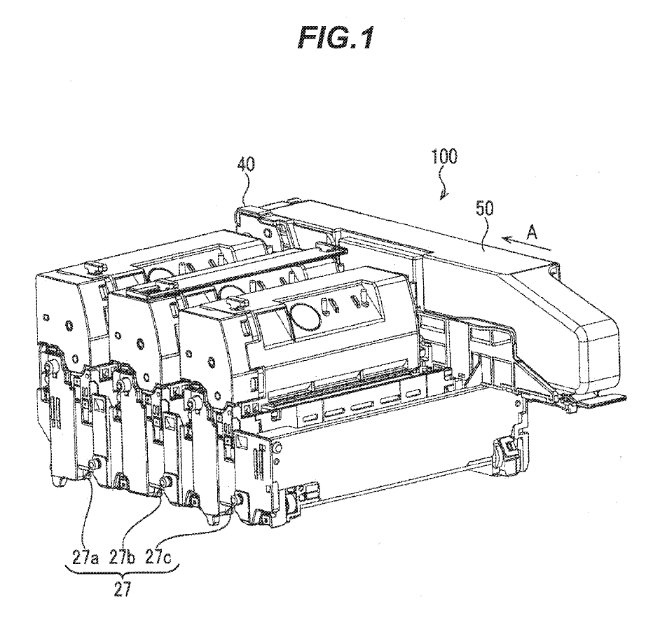

FIG. 1 is an external perspective view of an image forming unit 100 of the embodiment.

In FIG. 1, the image forming unit 100 includes the image forming portions 27, a stage 40, and a toner cartridge 30.

The image forming portions 27 form toner images as developer images using the electrophotographic method. The image forming portions 27 include the photosensitive drums 30a, 30b, and 30c (illustrated in FIG. 2) serving as rotatable image carriers, charging units that uniformly charge surfaces of the photosensitive drums, exposure units that selectively illuminate the charged surfaces of the photosensitive drums with light to form electrostatic latent images, and developing units that supply toner as developer to the electrostatic latent images formed on the photosensitive drums to form toner images.

In the image forming portions 27 of this embodiment, for example, the image forming portion 27a forms a yellow toner image, the image forming portion 27b forms a magenta toner image, and the image forming portion 27c forms a cyan toner image. The image forming portions 27a, 27b, and 27c are arranged in this order in the medium conveying direction.

The stage 40, serving as a mount portion, is disposed on a side of the image forming portions 27 in a direction perpendicular to the medium conveying direction (on the right side of the image forming apparatus 1 illustrated in FIG. 2). The stage 40 is configured so that the toner cartridge 50 is detachably attached to the stage 40.

The toner cartridge 50, serving as a developer container, stores toners of the different colors, and is configured to be detachably attached to the stage 40. When the toner in the image forming portions 27a, 27b, and 27c has run short, by removing the toner cartridge 50 attached to the stage 40 and inserting a new toner cartridge 50 storing the toners of the different colors into the stage 40 in the direction indicated by arrow A in the drawing to attach the toner cartridge 50 to the stage 40, it is possible to supply the image forming portions 27a, 27b, and 27c with the respective toners of different colors.

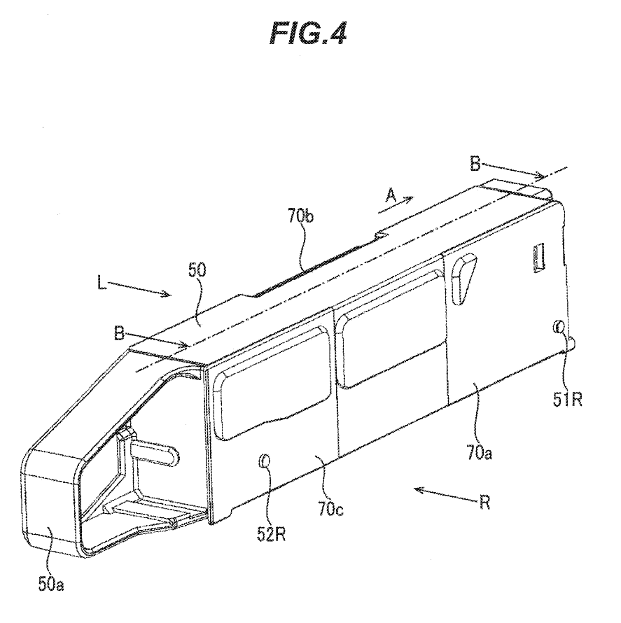

FIGS. 3 and 4 are external perspective views of the toner cartridge of the embodiment.

In FIGS. 3 and 4, the toner cartridge 50 has a left side surface on which posts 51L and 52L as projections are formed, and a right side surface on which posts 51R and 52R as projections are formed, as viewed in the direction indicated by arrow A in the drawings, in which the toner cartridge 50 is attached to the stage 40 illustrated in FIG. 1. The posts 51L, 52L, 51R, and 52R are substantially cylindrical. The posts 51L and 51R are formed on the front side of the toner cartridge 50 in the attachment direction indicated by arrow A in the drawings, and the posts 52L and 52R are formed on the back side of the toner cartridge 50 in the attachment direction indicated by arrow A in the drawings.

A handle 50a for an operator to handle the toner cartridge 50 is formed at a back end of the toner cartridge 50 in the attachment direction. While gripping the handle 50a, an operator can move the toner cartridge 50 relative to the stage 40 (see FIG. 1) in the attachment direction indicated by arrow A in the drawings to attach the toner cartridge 50 to the stage 40, and also can move the toner cartridge 50 relative to the stage 40 (see FIG. 1) in a direction opposite to the attachment direction indicated by arrow A in the drawings to remove the toner cartridge 50 from the stage 40.

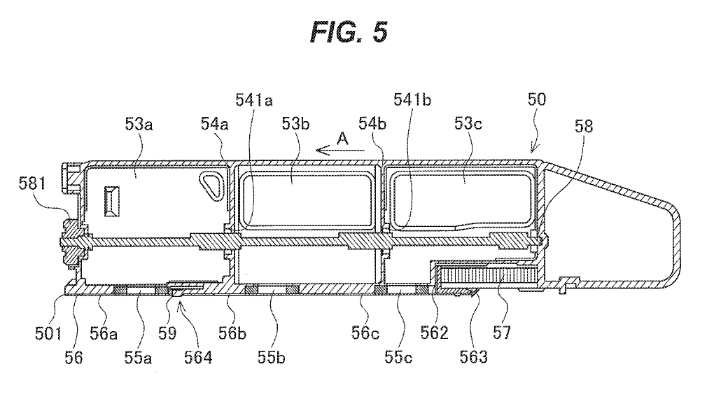

FIG. 5 is a sectional view of the toner cartridge of the embodiment taken along line B-B in FIG. 4.

In FIG. 5, the toner cartridge 50 includes toner storing portions 53a, 53b, and 53c, partitions 54a and 54b, openings 55a, 55b, and 55c, a shutter 56, a spring 57, an agitating member 58, and a stopper 59.

The toner storing portions 53a, 53b, and 53c, serving as developer chambers, are chambers that store the toners of the different colors, and are multiple (three in this embodiment) developer chambers arranged in the attachment direction (in which the toner cartridge 50 is attached to the stage 40) indicated by arrow A in the drawing. In this embodiment, the toner storing portions 53a, 53b, and 53c are arranged in this order from the front side (or downstream side) in the attachment direction.

The toner storing portion 53a stores, for example, yellow toner, the toner storing portion 53b stores, for example, magenta toner, and the toner storing portion 53c stores, for example, cyan toner. The toner storing portions 53a, 53b, and 53c are arranged to correspond to the image forming portions 27a, 27b, and 27c illustrated in FIG. 1, respectively.

In this embodiment, the number of toner storing portions is three, but it may be two, four, or more. The number of toner storing portions may correspond to the number of image forming portions.

The partitions 54a and 54b are walls that separate the toner storing portions. The partition 54a is disposed between the toner storing portions 53a and 53b, and the partition 54b is disposed between the toner storing portions 53b and 53c.

The openings 55a, 55b, and 55c, serving as first openings, are holes formed in lower portions of the toner storing portions 53a, 53b, and 53c and allow the toner stored in the toner storing portions 53a, 53b, and 53c to pass therethrough, respectively. In the attachment direction indicated by arrow A in the drawing, the openings 55a, 55b, and 55c have predetermined lengths and are arranged at predetermined intervals. The openings 55a, 55b, and 55c have the same length in the attachment direction.

The shutter 56, serving as an opening-closing member, is disposed at a lower portion of the toner cartridge 50 slidably in the attachment direction indicated by arrow A in the drawing (and the direction opposite thereto). The shutter 56 is a plate-shaped member, that closes or opens the openings 55a, 55b, and 55c, and forms a bottom surface of the toner cartridge 50.

In the shutter 56, openings 56a, 56b, and 56c are formed. In the attachment direction indicated by arrow A in the drawing, the openings 56a, 56b, and 56c have the same length as the openings 55a, 55b, and 55c, and are arranged at the same intervals as the openings 55a, 55b, and 55c. Thus, when the openings 56a, 56b, and 56c of the shutter 56 are located at positions corresponding to or facing the openings 55a, 55b, and 55c of the toner storing portions, they open the openings 55a, 55b, and 55c; when the openings 56a, 56b, and 56c of the shutter 56 are located at positions that do not correspond to or face the openings 55a, 55b, and 55c of the toner storing portions, they closes the openings 55a, 55b, and 55c.

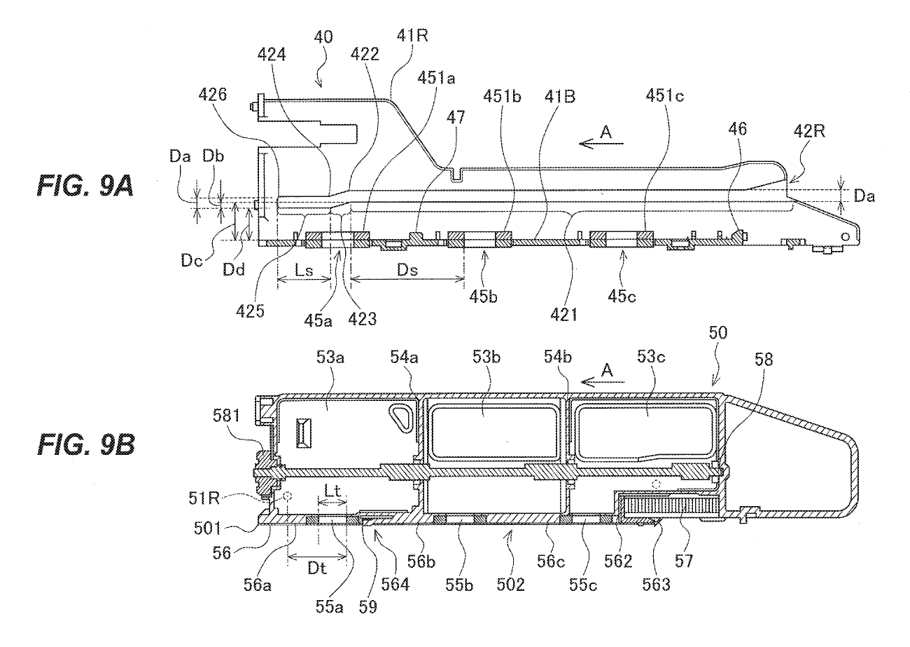

Further, in the shutter 56, an abutment portion 562 and an engaged portion 563 are formed. The abutment portion 562 abuts the spring 57. The engaged portion 563 engages with a projection 46 (see FIG. 9A) formed in the stage 40 illustrated in FIG. 1.

The spring 57, serving as an urging member, is an urging means that urges the shutter 56 in the attachment direction indicated by arrow A in the drawing. The shutter 56 urged by the spring 57 is stopped by abutting an abutment portion 501 disposed at a lower portion of the toner cartridge 50, and closes the openings 55a, 55b, and 55c of the toner storing portions. FIG. 5 illustrates a state where the shutter 56 is urged by the spring 57 of the toner cartridge 50 and closes the openings 55a, 55b, and 55c of the toner storing portions.

The agitating member 58 is a rotatable member extending in the attachment direction indicated by arrow A in the drawing, and is disposed to pass through the toner storing portions 53a, 53b, and 53c. A gear 581 is formed at a tip portion of the agitating member 58 in the attachment direction. Rotational drive from a drive source of the image forming apparatus 1 illustrated in FIG. 2 is transmitted to the gear 581, rotating the agitating member 58. The rotation of the agitating member 58 agitates the toner in the toner storing portions 53a, 53b, and 53c to prevent toner aggregation or the like.

A sealing member 541a is disposed between the partition 54a and the agitating member 58, and a sealing member 541b is disposed between the partition 54b and the agitating member 58. The sealing members 541a and 541b prevent toner leakage from the toner storing portions 53a, 53b, and 53c, and prevent mixture of the toners in the toner storing portions 53a, 53b, and 53c.

The stopper 59, serving as a locking member, has a projection formed at its tip. By engagement of the projection with a hole 564 formed in the shutter 56, the stopper 59 prevents or limits sliding of the shutter 56. The stopper 59 is supported, for example, in a cantilever manner such that the projection at the tip can move up and down. In this embodiment, the stopper 59 prevents or limits sliding of the shutter 56 to maintain the state where the shutter 56 closes (or opens) the openings 55a, 55b, and 55c. The stopper 59 may be omitted from the toner cartridge 50.

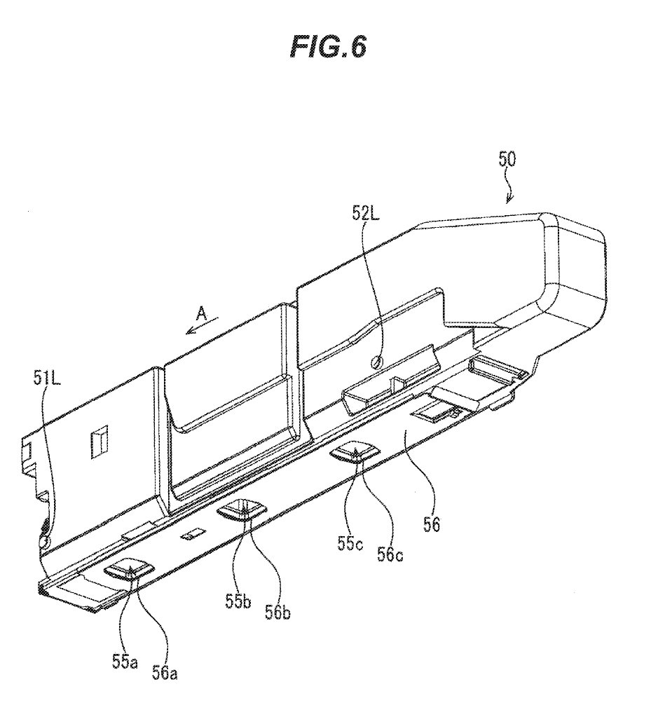

FIG. 6 is a perspective view of the toner cartridge of the embodiment as viewed from the bottom side of the toner cartridge.

FIG. 6 illustrates a state where the shutter 56 of the toner cartridge 50 opens the openings 55a, 55b, and 55c of the toner storing portions.

As illustrated in FIG. 6, when the openings 56a, 56b, and 56c of the shutter 56 are located at positions corresponding to or facing the openings 55a, 55b, and 55c of the toner storing portions (specifically, the toner storing portions 53a, 53b, and 53c illustrated in FIG. 5), the openings 55a, 55b, and 55c are opened. Thus, the toner stored in the toner storing portions 53a, 53b, and 53c illustrated in FIG. 5 falls through the openings 56a, 56b, and 56c and the openings 55a, 55c, and 55c, respectively, and is supplied to the image forming portions 27a, 27b, and 27c illustrated in FIG. 1.

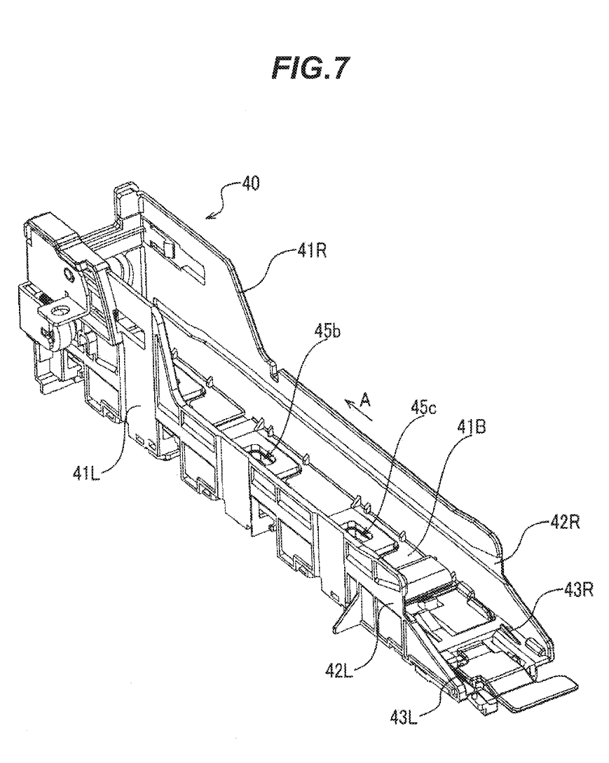

FIG. 7 is a perspective view of the stage of the embodiment.

In FIG. 7, the stage 40 includes side walls 41L and 41R, a bottom plate 41B, rails 42L and 42R, and limiters 43L and 43R.

The side walls 41L and 41R are walls formed on both left and right sides of the stage 40 as viewed in the toner cartridge attachment direction indicated by arrow A in the drawing. The bottom plate 41B forms a bottom portion of the stage 40.

The rails 42L and 42R, serving as guide portions, are guides (or guide grooves) formed in inner sides of the side walls 41L and 41R to extend in the toner cartridge attachment direction indicated arrow A in the drawing. The rails 42L and 42R slidably guide the toner cartridge 50 with the posts 51L and 51R or/and the posts 52L and 52R, which are projections formed on both sides of the toner cartridge 50 illustrated in FIGS. 3 and 4 fitted in the rails 42L and 42R.

The limiters 43L and 43R are projection-shaped members having predetermined heights. The limiters 43L and 43R are formed on inner sides of the side walls 41L and 41R and on both left and right sides of the bottom plate 41B to extend in the toner cartridge attachment direction indicated by arrow A in the drawing. When the posts 51L and 51R of the toner cartridge 50 illustrated in FIGS. 3 and 4 are fitted in the rails 42L and 42R, the limiters 43L and 43R abut both sides of the bottom surface of the toner cartridge 50, thereby separating the bottom surface of the toner cartridge 50 from the bottom plate 41B to prevent toner adhering to the bottom surface of the toner cartridge 50 from adhering to the bottom plate 41B and prevent toner adhering to the bottom plate 41B from adhering to the bottom surface of the toner cartridge 50.

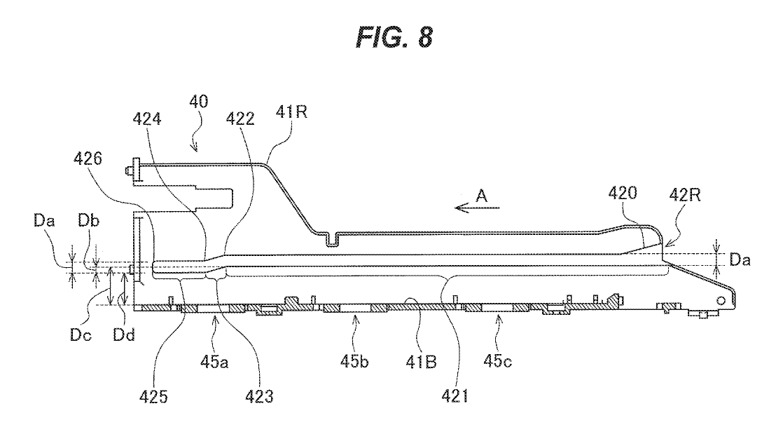

FIG. 8 is a view for explaining the stage and rails of the embodiment, and illustrates a side surface of the 42R illustrated in FIG. 7. The rail 42L has the same configuration as the rail 42R.

In FIG. 8, the stage 40 has openings 45a, 45b, and 45c.

The openings 45a, 45b, and 45c, serving as second openings, are holes formed in the bottom plate 41B, and are multiple holes formed to correspond to the openings 55a, 55b, and 55c of the toner cartridge 50 illustrated in FIG. 5. In the attachment direction indicated by arrow A in the drawing, the openings 45a, 45b, and 45c have the same length as the openings 55a, 55b, and 55c of the toner cartridge 50 illustrated in FIG. 5, and are arranged at the same intervals as the openings 55a, 55b, and 55c of the toner cartridge 50.

The openings 45a, 45b, and 45c correspond to and communicate with the image forming portions 27a, 27b, and 27c illustrated in FIG. 1, and can allow toner passing through the openings 55a, 55b, and 55c of the toner cartridge 50 to further pass therethrough and be supplied to the image forming portions 27a, 27b, and 27c, respectively.

The rail 42R has a first linear section 421, a first corner 422, a slope section 423, a second corner 424, and a second linear section 425.

The first linear section 421 is a linear section extending from an insertion inlet 420, which is a most upstream portion of the rail 42R in the toner cartridge attachment direction indicated by arrow A in the drawing, to the first corner 422. The first linear section 421 is formed substantially parallel to the bottom plate 41B (or bottom surface).

The first corner 422 is formed at the downstream end of the first linear section 421 in the toner cartridge attachment direction.

The slope section 423, serving as a connection, is formed downstream of the first corner 422 in the toner cartridge attachment direction. The slope section 423 is inclined at a predetermined angle in a direction such that it approaches the bottom plate 41B downstream in the toner cartridge attachment direction.

The second corner 424 is formed at the downstream end of the slope section 423 in the toner cartridge attachment direction.

The second linear section 425 is formed downstream of the second corner 424 in the toner cartridge attachment direction, and is a linear section extending from the second corner 424 to a terminal end 426, which is a most downstream portion of the rail 42R in the toner cartridge attachment direction. The second linear section 425 is formed substantially parallel to the bottom plate 41B (or bottom surface).

In this manner, the rail 42R has the first linear section 421 formed on the upstream side in the toner cartridge attachment direction, the second linear section 425 located downstream of the first linear section 421 in the toner cartridge attachment direction, and the slope section 423 connecting the downstream end of the first linear section 421 in the toner cartridge attachment direction and the upstream end of the second linear section 425 in the toner cartridge attachment direction.

A height (or width) of the rail 42R is Da, and is substantially equal to or slightly larger than diameters of the posts 51R and 52R which are substantially cylindrical, of the toner cartridge 50 illustrated in FIG. 4.

A difference in height between a lower surface of the first linear section 421 and a lower surface of the second linear section 425 is Db.

In this embodiment, the difference Db in height is one-half of the height Da; for example, the height Da is 4 mm and the height difference Db is 2 mm.

Thus, a distance Dc between the first linear section 421 and the bottom plate 41B (or bottom surface) is greater than a distance Dd between the second linear section 425 and the bottom plate 41B (or bottom surface).

FIGS. 9A and 9B are explanatory views illustrating a positional relationship between the rails and the posts in the embodiment. FIG. 9A is a sectional view of the stage 40, and illustrates the rail 42R. FIG. 9B is a sectional view of the toner cartridge 50 taken along line B-B in FIG. 4.

As illustrated in FIG. 9A, in the toner cartridge attachment direction indicated by arrow A in the drawing, a distance between the first corner 422, which is the downstream end of the first linear section 421, of the rail 42R of the stage 40, and the downstream end of the opening 45b, which is the second opening from the most downstream side, is denoted by Ds.

As illustrated in FIG. 3B, in the toner cartridge attachment direction, a distance between a center of the post 51R of the toner cartridge 50 and the upstream end of the opening 55a is denoted by Dt. The post 51R is located downstream of the most downstream opening 55a in the toner cartridge attachment direction.

In this embodiment, the rail 42R, opening 45b, post 51R, and opening 55a are formed to satisfy at least the relationship of Ds>Dt.

This is to ensure that when the post SIR of the toner cartridge 50 has reached the first corner 422 after the toner cartridge 50 is slid in the attachment direction with the post SIR fitted in the rail 42R, the opening 55a of the toner cartridge 50 is located downstream of the opening 45b of the stage 40 in the attachment direction.

Thereby, when there is toner adhering to the toner cartridge 50 around the opening 55a, it is possible to prevent the toner from adhering to the opening 45b of the stage 40, thereby preventing mixture of toners of different colors.

As illustrated in FIG. 9A, in the toner cartridge attachment direction indicated by arrow a in the drawing, a length of the second linear section 425 (in this embodiment, a distance between a center of the post 51R and the second corner 424 when the post 51R of the toner cartridge 50 abuts the terminal end 426 of the rail 42R of the stage 40) is denoted by Ls.

As illustrated in FIG. 9B, in the toner cartridge attachment direction, a length of the opening 55a of the toner cartridge 50, i.e., a distance between the upstream end and the downstream end of the opening 55a, is denoted by Lt.

In this embodiment, the rail 42R and opening 55a are formed to satisfy at least the relationship of Ls>Lt.

This is to ensure that when the post 51R of the toner cartridge 50 has reached the terminal end 426 after the toner cartridge 50 is slid in the attachment direction with the post 52R fitted in the rail 42R, the opening 56a of the shutter 56 corresponds to or faces the opening 55a of the toner cartridge 50.

A reason why the length of the second linear section 425 is taken as the distance Ls is because the post 51R can have a pin shape with a small radius.

In this embodiment, as illustrated in FIG. 9A, projections 46 and 47, serving as engaging portions, are formed on the bottom plate 41B of the stage 40. When the post 51R of the toner cartridge 50 illustrated in FIG. 9B has reached the second corner 424, the projection 47 of the stage 40 abuts the projection at the tip of the stopper 59 of the toner cartridge 50, thereby releasing the engagement of the stopper 59 with the hole 564 of the shutter 56 and allowing the shutter 56 to slide relative to the toner cartridge 50. Further, when the post 51R of the toner cartridge 50 illustrated in FIG. 9B has reached the second corner 424, the engaged portion 563 of the shutter 56 of the toner cartridge 50 abuts and engages with the projection 46.

In this embodiment, as illustrated in FIG. 9A, sealing members 451a, 451b, and 451c that prevent toner leakage are provided on contact surfaces of the stage 40 around the openings 45a, 45b, and 45c that abut the toner cartridge 50.

The rail 42L of the stage 40 has the same configuration as the rail 42R.

In this manner, while guiding the toner cartridge 50 in the toner cartridge attachment direction indicated by arrow A in the drawings, the rails 42R and 42L cause a first surface (or the bottom surface) 502 formed by the shutter 56 of the toner cartridge 50 to approach and separate from a second surface (or upper surface) 402 of the bottom plate 41B of the stage 40 in which the openings 45a, 45b, and 45c are formed.

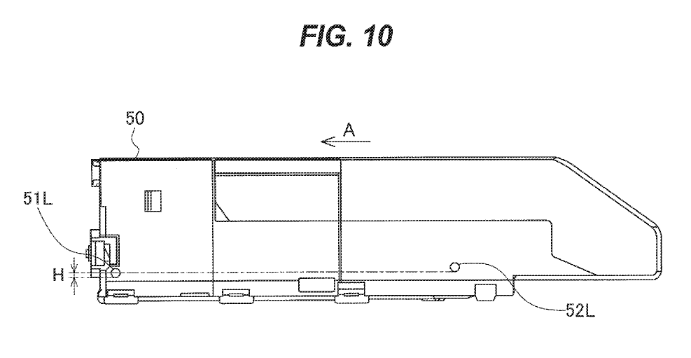

FIG. 10 is a side view of the toner cartridge of the embodiment for explaining the posts of the toner cartridge.

In FIG. 10, a difference in height between the lower end of the post 51L and the lower end of the post 52L of the toner cartridge 50 is H. In this embodiment, the difference H is equal to the height difference Db between the lower surface of the first linear section 421 and the lower surface of the second linear section 425 of the stage 40 illustrated in FIG. 8, and is 2 mm.

This is to ensure that when the toner cartridge 50 has been attached to the stage 40 illustrated in FIG. 8, the bottom surface of the toner cartridge 50 is in close contact with the bottom plate 41B of the stage 40 with respect to the toner cartridge attachment direction indicated by arrow A in the drawing. Thus, it is possible to bring the openings of the toner cartridge 50 into close contact with the openings of the stage 40.

FIG. 11 is a view for explaining the limiters of the stage of the embodiment. FIG. 11 is an explanatory view illustrating a state where the toner cartridge 50 is being attached to the stage 40 with the posts 51L and 51R of the toner cartridge 50 illustrated in FIGS. 3 and 4 fitted in the rails 42L and 42R of the stage 40 illustrated in FIG. 7.

As illustrated in FIG. 11, in a state where the toner cartridge 50 is incompletely attached to the stage 40, the toner cartridge 50 can rotate about the post 51R in the direction indicated by arrow C in the drawing.

At this time, the bottom surface of the toner cartridge 50 abuts the limiters 43L and 43R, limiting the rotation of the toner cartridge 50. Thus, a gap is formed between the shutter 56 of the toner cartridge 50 and the sealing members 451a, 451b, and 451c of the stage 40.

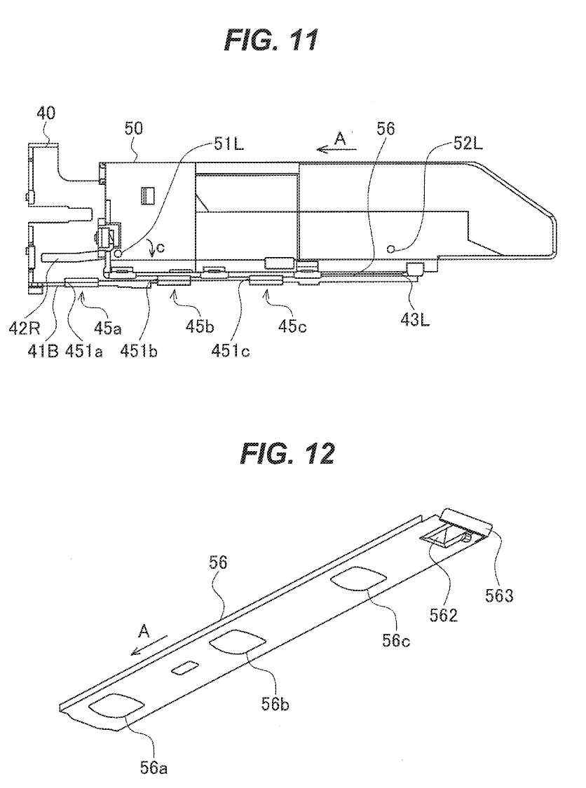

FIG. 12 is a perspective view of the shutter of the toner cartridge of the embodiment.

In FIG. 12, in the shutter 56, the openings 56a, 56b, and 56c are formed at regular intervals in this order from the downstream side in the toner cartridge attachment direction indicated by arrow A in the drawing so that they correspond to the openings 55a, 55b, and 55c of the toner cartridge 50 illustrated in FIG. 6. Thus, the shutter 56 can simultaneously open and close the openings 55a, 55b, and 55c of the toner cartridge 50 by sliding relative to the toner cartridge 50.

The engaged portion 563, which engages with the projection 46 of the stage 40, is formed at a back end of the shutter 56 in the toner cartridge attachment direction. The engaged portion 563 is formed to project downward from the bottom surface of the shutter 56.

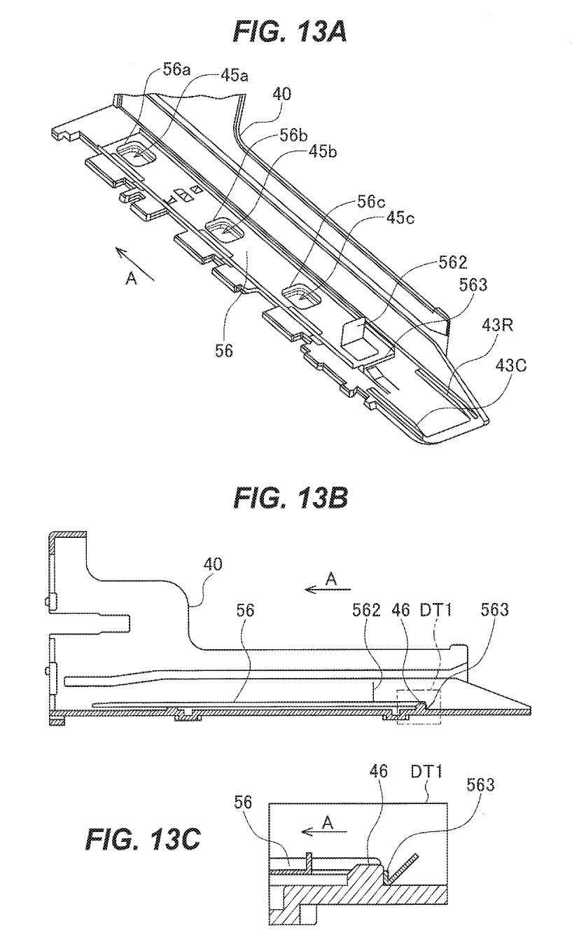

FIGS. 13A-13C are views for explaining engagement between the shutter and the stage in the embodiment, and illustrate a state where the engaged portion 563 of the shutter 56 and the projection 46 of the stage 40 are engaged with each other. FIG. 13A is a perspective view of the stage 40 and shutter 56. FIG. 13B is a sectional view of the stage 40 and shutter 56. FIG. 13C is an enlarged view of the engagement portion DT1 in FIG. 13B.

In FIGS. 13A-13C, the engaged portion 563 of the shutter 56 engages with the projection 46 of the stage 40, thereby restricts or prevents movement of the shutter 56 in the toner cartridge attachment direction indicated by arrow A in the drawings.

At this time, the shutter 56 is located at a position where the openings 56a, 56b, and 56c of the shutter 56 correspond to or face the openings 45a, 45b, and 45c of the stage 40.

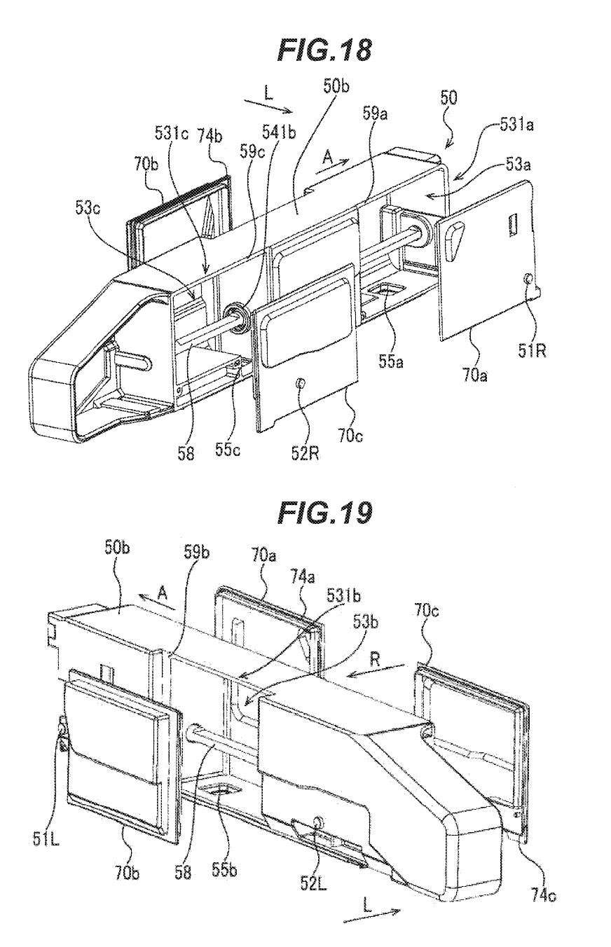

FIGS. 18 and 19 are exploded perspective views of the toner cartridge of the embodiment.

In FIGS. 18 and 19, the toner cartridge 50 includes a frame 50b and covers 70a, 70b, and 70c that close or seal openings 531a, 531b, and 531c of the toner storing portions 53a, 53b, and 53c. The covers 70a, 70b, and 70c are rectangular.

The toner storing portions 53a, 53b, and 53c are arranged in the frame 50b. The frame 50b, serving as a body of the toner cartridge 50, forms wall surfaces of the respective toner storing portions 53a, 53b, and 53c, and has the openings 531a, 531b, and 531c formed therein for the toner storing portions 53a, 53b, and 53c.

The cover 70a seals the opening 531a of the toner storing portion 53a. The cover 70a closes the opening 531a of the toner storing portion 53a by being joined to a welded portion 59a of the opening 531a that has a substantially hollow square shape and is provided in the frame 50b of the toner cartridge 50.

The cover 70b seals the opening 531b of the toner storing portion 53b. The cover 70b closes the opening 531b of the toner storing portion 53b by being joined to a welded portion 59b of the opening 531b that has a substantially hollow square shape and is provided in the frame 50b of the toner cartridge 50.

The cover 70b seals the opening 531b of the toner storing portion 53b. The cover 70b closes the opening 531b of the toner storing portion 53b by being joined to a welded portion 59b of the opening 531b that has a substantially hollow square shape and is provided in the frame 50b of the toner cartridge 50.

The cover 70c seals the opening 531c of the toner storing portion 53c. The cover 70c closes the opening 531c of the toner storing portion 53c by being joined to a welded portion 59c of the opening 531c that has a substantially hollow square shape and is provided in the frame 50b of the toner cartridge 50.

The covers 70a and 70c are disposed on the right (R) side as viewed in the toner cartridge attachment direction indicated by arrow A in the drawings, and the cover 70b is disposed on the left (L) side as viewed in the toner cartridge attachment direction.

Thus, the opening 531a of the toner storing portion 53a and the opening 531c of the toner storing portion 53c are formed on the right (R) side as viewed in the toner cartridge attachment direction indicated by arrow A in the drawings, and the opening 531b of the toner storing portion 53b is formed on the left (L) side as viewed in the toner cartridge attachment direction.

In the cover 70a, the post 51R is formed at a position corresponding to the post 51L. In the cover 70c, the post 52R is formed at a position corresponding to the post 52L.

In the cover 70a, a welding rib 74a serving as a welding portion is formed. The welding rib 74a has a substantially hollow square shape. The welding rib 74a and the welded portion 59a, which serves as an engaged portion (or engaged groove) and is provided in the frame 50b of the toner cartridge 50, are engaged with and welded to each other. This closes or seals the opening 531a of the toner storing portion 53a and prevents toner from leaking from the toner storing portion 53a.

In the cover 70b, a welding rib 74b serving as a welding portion is formed. The welding rib 74b has a substantially hollow square shape. The welding rib 74b and the welded portion 59b, which serves as an engaged portion (or engaged groove) and is provided in the frame 50b of the toner cartridge 50, are engaged with and welded to each other. This closes or seals the opening 531b of the toner storing portion 53b and prevents toner from leaking from the toner scoring portion 53b.

In the cover 70c, a welding rib 74c serving as a welding portion is formed. The welding rib 74c has a substantially hollow square shape. The welding rib 74c and the welded portion 59c, which serves as an engaged portion (or engaged groove) and is provided in the frame 50b of the toner cartridge 50, are engaged with and welded to each other. This closes or seals the opening 531c of the toner storing portion 53c and prevents toner from leaking from the toner storing portion 53c.

In this embodiment, the openings 531a, 531b, and 531c of the toner storing portions 53a, 53b, and 53c have different shapes, and the covers 70a, 70b, and 70c have shapes corresponding to the shapes of the openings 531a, 531b, and 531c, respectively.

As above, in this embodiment, each toner storing portion has an opening, and for each toner storing portion, a cover that closes the opening of the toner storing portion is provided. The covers for the toner storing portions are separately provided. The covers correspond to the openings of the toner storing portions on a one-to-one basis. Specifically, for the toner storing portions 53a, 53b, and 53c, the covers 70a, 70b, and 70c that respectively close the openings 531a, 531b, and 531c of the toner storing portions 53a, 53b, and 53c are provided. The covers 70a, 70b, and 70c are separately provided to correspond to the openings 531a, 531b, and 531c.

Further, the openings 531a and 531c of the toner storing portions 53a and 53c and the covers 70a and 70c that close the openings 531a and 531c are provided on one side as viewed in the toner cartridge attachment direction, and the opening 531b of the toner storing portion 53b adjacent to the toner storing portions 53a and 53c and the cover 70b that closes the opening 531b are provided on the other side as viewed in the toner cartridge attachment direction.

Thus, the toner cartridge 50 of this embodiment includes at least a first developer chamber (e.g., the toner storing portion 53a) and a second developer chamber (e.g., the toner storing portion 53b) that are arranged adjacent to each other. The opening (e.g., the opening 531a) of the first developer chamber and the opening (e.g., the opening 531b) of the second developer chamber are formed in different sides (e.g., opposite sides) of the frame 50b.

In this embodiment, the opening (e.g., the opening 531b) of the second developer chamber is formed in a side (or side surface) of the frame 50b opposite to the side of the frame 50b in which the opening (e.g., the opening 531a) of the first developer chamber is formed. However, this is not mandatory, and the opening of the second developer chamber may be formed in an upper or lower side (or surface) of the toner cartridge 50.

The same applies to a case where the toner storing portion 53b is taken as the first developer chamber and the toner storing portion 53c is taken as the second developer chamber.

The covers will now be described.

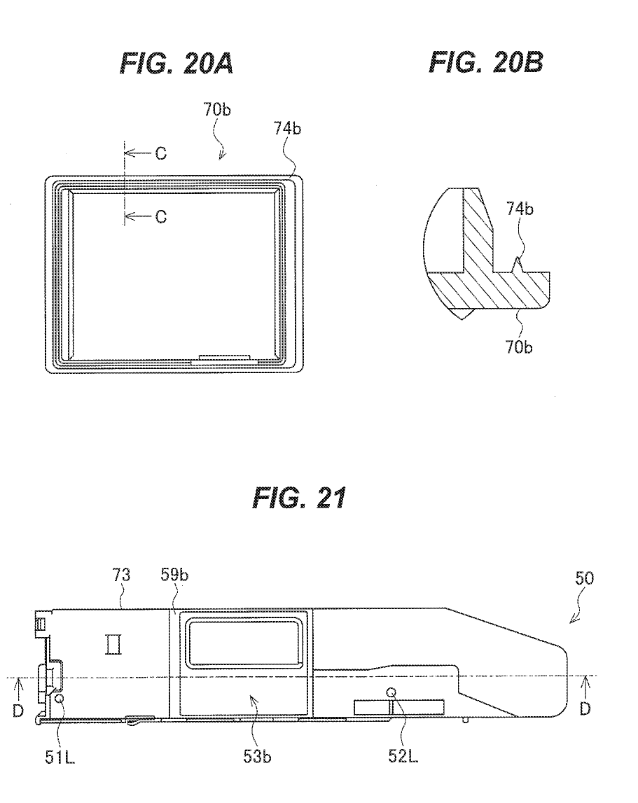

FIGS. 20A and 20B are views for explaining the covers of the embodiment. The covers 70a, 70b, and 70c illustrated in FIGS. 18 and 19 have substantially the same configuration, and FIG. 20 illustrates a configuration of the cover 70b.

FIG. 20A is a view of the cover 70b in FIG. 18 as viewed in the direction indicated by arrow R in FIG. 19. FIG. 20B is a sectional view of the welding rib 74b taken along line C-C in FIG. 20A.

As illustrated in FIG. 20A, the welding rib 74b, which has a substantially hollow square shape, is formed on a surface of the cover 70b (illustrated in FIG. 19) on the toner storing portion 53b side.

As illustrated in FIG. 20B, the welding rib 74b is a projection having, for example, a substantially isosceles triangular cross section.

FIG. 21 is a side view of the toner cartridge of the embodiment as viewed in the direction of arrow L in FIG. 19.

The welding rib 74b of the cover 70b illustrated in FIGS. 20A and 20B is fitted into the welded portion 59b of the toner cartridge 50 illustrated in FIG. 21, and the welding rib 74b and welded portion 59b are welded together, so that the toner storing portion 53b is sealed.

In this manner, in this embodiment, the welding rib 74b is welded to the welded portion 59b of the toner cartridge 50 illustrated in FIG. 21, so that the opening 531b illustrated in FIG. 19 is sealed by the cover 70b.

Here, the welding is performed using, for example, ultrasonic welding. However, attachment of the cover 70b to the toner cartridge 50 is not limited to ultrasonic welding, and the cover 70b may be joined to the toner cartridge 50 with adhesive, silicone rubber, or double-sided adhesive tape, or by other methods.

Likewise, the cover 70a illustrated in FIGS. 18 and 19 is fitted into the welded portion 59a of the toner cartridge 50, and the welding rib 74a and welded portion 59a are welded together, so that the toner storing portion 53a is sealed; the cover 70c illustrated in FIGS. 18 and 19 is fitted into the welded portion 59c of the toner cartridge 50, and the welding rib 74c and welded portion 59c are welded together, so that the toner storing portion 53c is sealed.

An operation of the above-described configuration will be described.

First, an operation of the image forming apparatus will be briefly described with reference to FIG. 2.

A paper roll is set in the paper roll holder 3 by a user in such a manner that a leading end portion of the paper is drawn from the paper roll in front of the paper roll holder 3. Then, the cover 6 is closed, and the paper is nipped between the holder side conveying roller 9 and the cover side conveying roller 11.

With the paper nipped between the holder side conveying roller 9 and the cover side conveying roller 11, the image forming apparatus 1 rotates the holder side conveying roller 9 and rotates one conveying roller of each of the pairs of conveying rollers 22, 23, 24, 25, and 33, thereby conveying the paper to the transfer belt 29 along the conveying path 21.

The paper conveyed to the transfer belt 29 is conveyed by the transfer belt 29 and sequentially passes through between the photosensitive drums 30a, 30b, and 30c of the image forming portions 27a, 27b, and 27c and the transfer rollers 31a, 31b, and 31c. At this time, toner images formed on the surfaces of the photosensitive drums 30a, 30b, and 30c are transferred onto a printing surface of the paper.

The paper with the toner images transferred thereon is conveyed to the fixing unit 32, which fixes the toner images to the paper. The paper is then discharged by the pair of conveying rollers 33 through the paper outlet 20.

The paper is cut by the housing side cutter 26 to a predetermined length. Thus, a printed sheet cut to the predetermined length is discharged through the paper outlet 20.

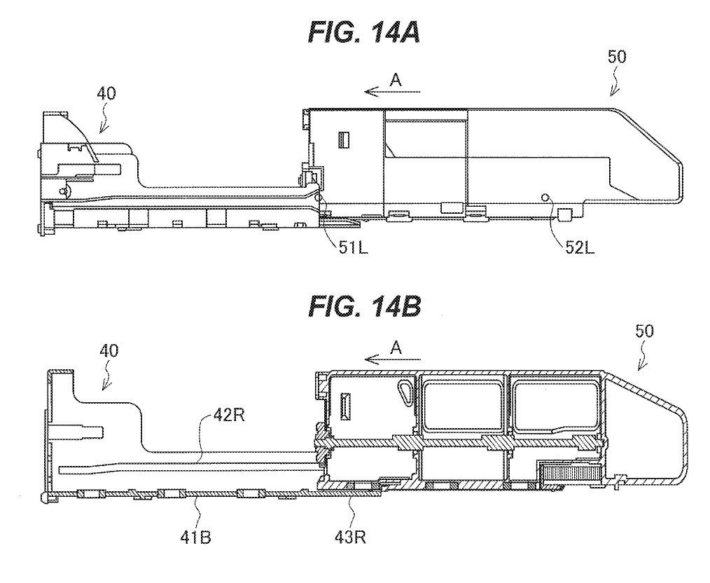

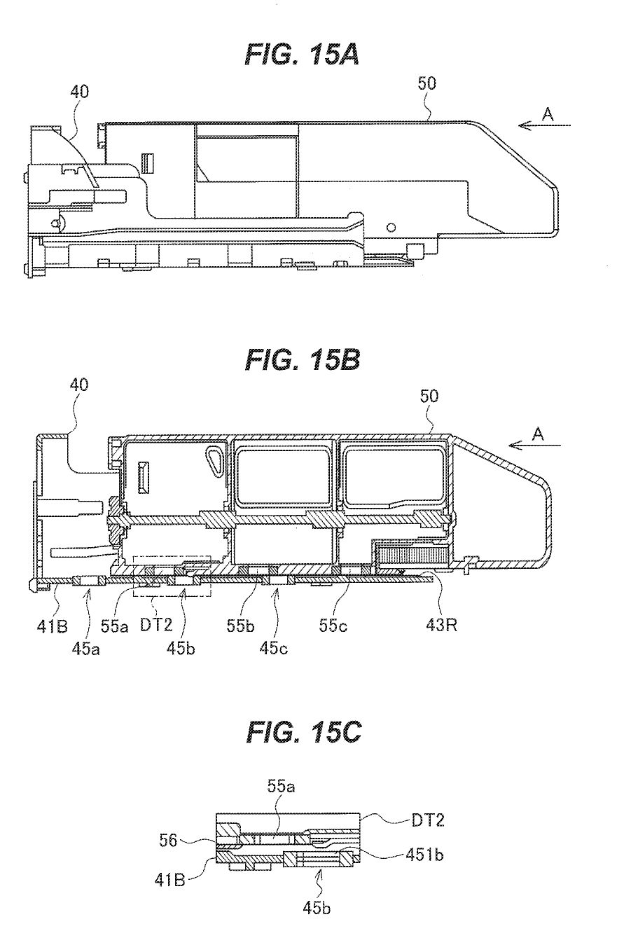

Next, an operation of attaching the toner cartridge to the stage will be described with reference to FIGS. 14A, 14B, 15A-15C, 16A-16C, and 17A-17C. FIGS. 14A, 15A, 16A and 17A are left side views of the stage 40 and toner cartridge 50. FIGS. 14B, 15B, 16B, and 17B are sectional views of the stage 40 and toner cartridge 50 corresponding to FIGS. 14A, 15A, 16, and 17A. FIGS. 15C, 16C, and 17C are enlarged views of the parts DT2, DT3, and DT4 of FIGS. 15B, 16B, and 17E, respectively.

FIGS. 14A and 14B illustrate a state before the posts 51R and 51L of the toner cartridge 50 are fitted into the rails 42R and 42L of the stage 40.

At this time, a front end portion of the bottom surface of the toner cartridge 50 in the toner cartridge attachment direction indicated by arrow A in the drawings abuts the limiters 43R and 43L. This separates the bottom surface of the toner cartridge 50 from the bottom plate 41B of the stage 40 and forms a predetermined gap therebetween.

From this state, the posts 51R and 51L of the toner cartridge 50 are fitted into the rails 42R and 42L of the stage 40, and the toner cartridge 50 is slid in the toner cartridge attachment direction indicated by arrow A in the drawings.

FIGS. 15A-15C illustrate a state immediately before the posts 51L and 51R of the toner cartridge 50 illustrated in FIGS. 3 and 4 reach the first corners 422 of the rails 42R and 42L of the stage 40 illustrated in FIG. 8.

At this time, as illustrated in FIGS. 15b and 15C, the bottom surface of the toner cartridge 50 and the bottom plate 41B of the stage 40 are separated from each other, and a predetermined gap is formed therebetween.

This is because, as illustrated in FIG. 8, the first linear sections 421 of the rails 42R and 42L of the stage 40 are higher by the distance Db than the second linear sections 425. The bottom surface of the toner cartridge 50 and the bottom plate 41B of the stage 40 are separated from each other, and the predetermined gap is formed therebetween.

Also, on the upstream side in the toner cartridge attachment direction indicated by arrow A in the drawings, the limiters 43R and 43L abut the bottom surface of the toner cartridge 50, thereby separating the bottom surface of the toner cartridge 50 from the bottom plate 41B of the stage 40 and maintaining the predetermined gap formed therebetween.

Thus, as illustrated in FIG. 15C, a predetermined gap is formed between the shutter 56 of the toner cartridge 50 and the sealing member 451b of the stage 40, in the up-down direction.

Also, a predetermined gap is formed between the shutter 56 of the toner cartridge 50 and the sealing member 451c (see FIG. 11) of the stage 40, in the up-down direction.

In this manner, until the opening 55a of the toner cartridge 50 passes through the opening 45b of the stage 40, the shutter 56 of the toner cartridge 50 and the sealing member 451b of the opening 45b of the stage 40 are separated from each other. Thus, the bottom surface of the toner cartridge 50 does not come into contact with the openings 45a, 45b, and 45c of the stage 40.

Thus, it is possible to prevent the bottom surface of the toner cartridge 50 and the openings 45a, 45b, and 45c of the stage 40 from being contaminated by toners of the different colors.

In the state illustrated in FIGS. 14A and 14B and the state illustrated in FIGS. 15A and 15B, the shutter 56 of the toner cartridge 50 is urged by the spring 57 to close the openings 55a, 55b, and 55c as illustrated in FIG. 5.

The toner cartridge 50 is further slid in the toner cartridge attachment direction indicated by arrow A in the drawings.

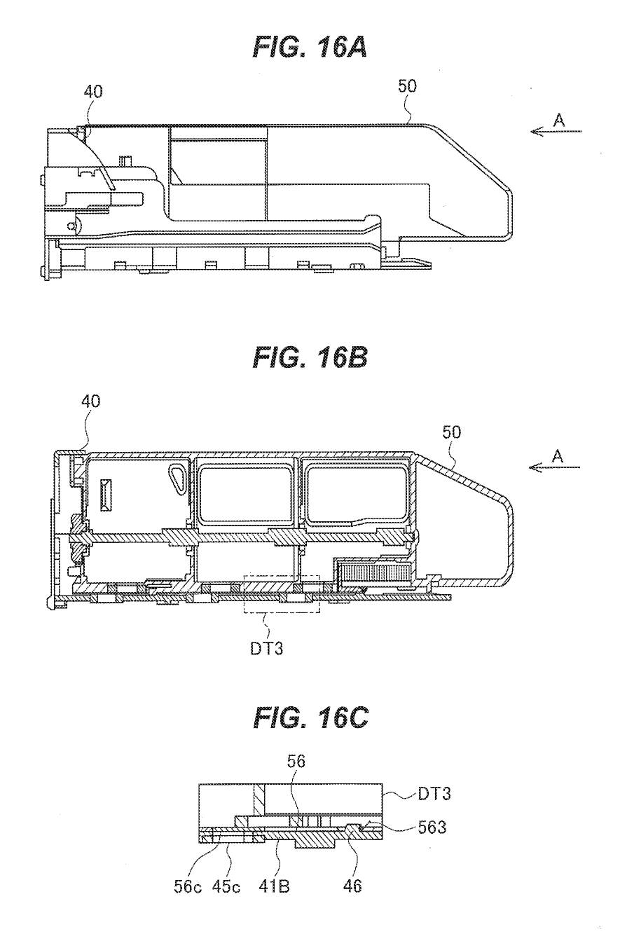

FIGS. 16A-16C illustrate a state where the posts 51R and 51L of the toner cartridge 50 illustrated in FIGS. 3 and 4 have reached the second corners 424 the upstream ends of the second linear sections 425 in the toner cartridge attachment direction) of the rails 42R and 42L of the stage 40 illustrated in FIG. 8.

At this time, as illustrated in FIGS. 16B and 16C, the bottom surface (or the first surface 502 illustrated in FIG. 9) of the toner cartridge 50 is close to the bottom plate 41B (or the second surface 402 illustrated in FIG. 9) of the stage 40, and the projection 46 of the stage 40 engages with the engaged portion 563 of the shutter 56 of the toner cartridge 50.

This is because, as illustrated in FIG. 8, the second linear sections 425 of the rails 42R and 42L of the stage 40 are lower by the distance Db than the first linear sections 421. The bottom surface of the toner cartridge 50 is close to the bottom plate 41B of the stage 40, and the engaged portion 563 of the shutter 56 of the toner cartridge 50 engages with the projection 46 of the stage 40.

This prevents or limits movement of the shutter 56 in the toner cartridge attachment direction. At this time, as illustrated in FIG. 16C, the opening 56c of the shutter 56 is located at a position corresponding to or facing the opening 45c of the stage 40, and likewise the openings 56a and 56b of the shutter 56 are located at positions corresponding to or facing the openings 45a and 45b of the stage 40 as illustrated in FIG. 6.

Further, since the height difference H between the posts 51R and 51L and the posts 52R and 52L of the toner cartridge 50 is equal to the distance Db, which is the difference in height between the second linear sections 425 and the first linear sections 421 of the rails 42R and 42L of the stage 40 illustrated in FIG. 8, as illustrated in FIG. 10, when the toner cartridge 50 moves in the attachment direction, the toner cartridge 50 is kept parallel to the stage 40, i.e., horizontal. This allows the three openings 56a, 56b, and 56c of the shutter 56 to respectively come into close contact with the three openings 45a, 45b, and 45c of the stage 40.

The toner cartridge 50 is further slid in the toner cartridge attachment direction indicated by arrow A in the drawings.

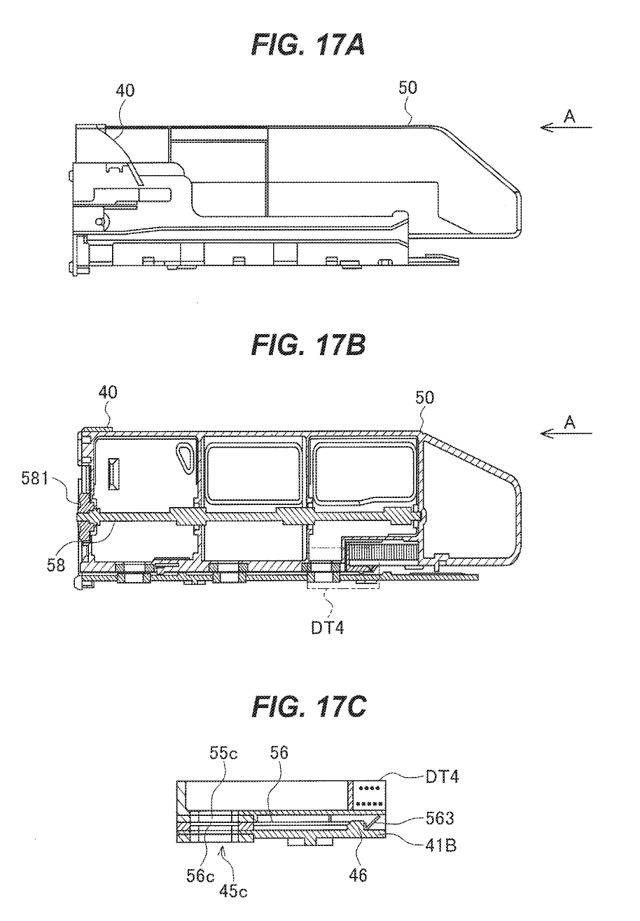

FIGS. 17A-17C illustrate a state where the posts 51R and 51L of the toner cartridge 50 illustrated in FIGS. 3 and 4 have reached the terminal ends 426 of the rails 42R and 42L or stage 40 illustrated in FIG. 8.

At this time, as illustrated in FIGS. 17B and 17C, the bottom surface of the toner cartridge 50 is kept close to the bottom plate 41B of the stage 40, and the opening 55c of the toner cartridge 50 is located at a position corresponding to or facing the opening 56c of the shutter 56 and the opening 45c of the stage 40, and likewise the openings 55a and 55b of the toner cartridge 50 illustrated in FIG. 6 are located at positions corresponding to or facing the openings 56a and 56b of the shutter 56 and the openings 45a and 45b of the stage 40 illustrated in FIG. 7.

This is because, when the posts 51R and 51L of the toner cartridge 50 illustrated in FIGS. 3 and 4 reach the terminal ends 426 of the rails 42R and 42L of the stage 40 illustrated in FIG. 8, movement of the toner cartridge 50 is prevented or limited at a position where the openings 55a, 55b, and 55c of the toner cartridge 50 respectively correspond to or face the openings 56a, 56b, and 56c of the shutter 56, which has already been prevented from moving in the toner cartridge attachment direction.

Accordingly, the toner stored in the toner cartridge 50 falls through the openings (specifically, the openings 55a, 55b, and 55c illustrated in FIG. 6) of the toner cartridge 50, the openings (specifically, the openings 56a, 56b, and 56c illustrated in FIG. 6) of the shutter 56, and the openings (specifically, the openings 45a, 45b, and 45c illustrated in FIG. 7) of the stage 40, and is supplied to the image forming portions 27a, 27b, and 27c illustrated in FIG. 1.

When the posts 51R and 51L of the toner cartridge 50 illustrated in FIGS. 3 and 4 reach the terminal ends 426 of the rails 42R and 42L of the stage 40 illustrated in FIG. 8, the gear 581 meshes with a gear connected to the drive source of the image forming apparatus 1 illustrated in FIG. 2, allowing the agitating member 53 to be rotated.

Next, a method of assembling the toner cartridge will be described.

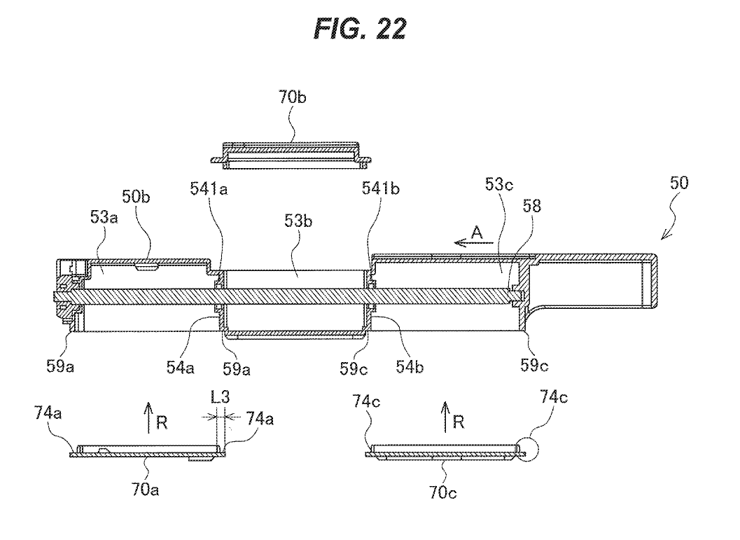

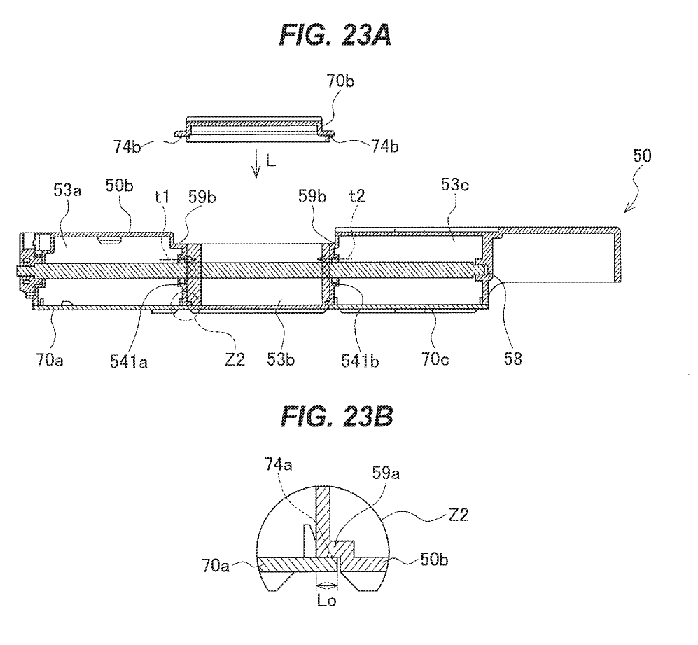

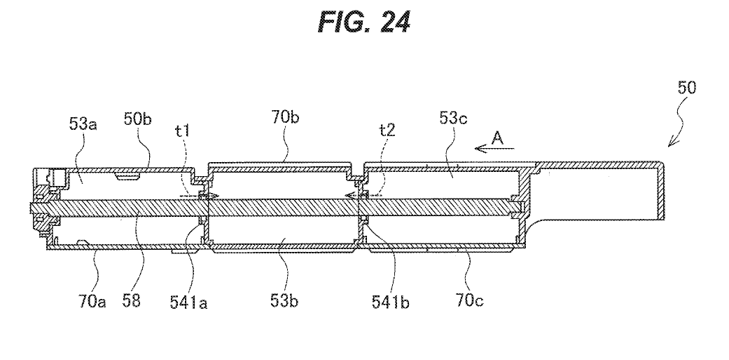

FIG. 22 is a sectional view of the toner cartridge of the embodiment before the covers are attached. FIGS. 23A and 23B are sectional views of the toner cartridge of the embodiment after two of the covers are attached. FIG. 24 is a sectional view of the toner cartridge of the embodiment after all the covers are attached, and is a sectional view taken along line D-D in FIG. 21.

FIG. 23B is an enlarged view of the joint part Z2 between the welded portion 59a of the frame 50b and the welding rib 74a of the cover 70a in FIG. 23A.

In FIG. 22, the cover 70a is moved toward the toner storing portion (or toner chamber) 53a in the direction indicated by arrow R in the drawing, and the welding rib 74a of the cover 70a and the welded portion 59a of the toner storing portion 53a are fitted together. With the welding rib 74a and the welded portion 59a fitted together, the welding rib 74a is melted by welding, so that the cover 70a is fixed to the frame 50b as illustrated in FIG. 23A.

At this time, as illustrated in FIG. 23B, the welding rib 74a of the cover 70a is melted and joined to the welded portion 59a of the toner storing portion 53a, so that the cover 70a is fixed to the frame 50b.

Likewise, the cover 70c is moved toward the toner storing portion (or toner chamber) 53c in the direction indicated by arrow R in FIG. 22, and the welding rib 74c of the cover 70c and the welded portion 59c of the toner storing portion 53c axe fitted together. With the welding rib 74c and the welded portion 59c fitted together, the welding rib 74c is melted by welding, so that the cover 70c is fixed to the frame 50b as illustrated in FIG. 23A.

After the covers 70a and 70c have been fixed to the frame 50b as illustrated in FIG. 23A, the toner storing portions 53a and 53c are filled with the respective toners. For example, the toner storing portion 53a is filled with yellow toner, and the toner storing portion 53c is filled with cyan toner.

At this time, the toners are supplied through the openings 55a and 55c illustrated in FIG. 6. It is also possible that the toner storing portions 53a and 53c are filled with the respective toners before the covers 70a and 70c are welded, and then the covers 70a and 70c are welded.

After the toner storing portions 53a and 53c have been filled with the toners, the toner cartridge 50 is shaken, and it is visually checked whether toner leaks from the toner storing portions 53a and 53c of the toner cartridge 50 being assembled.

When it is determined that no toner leaks from the toner storing portions 53a and 53c into the toner storing portion 53b adjacent to the toner storing portions 53a and 53c, no toner leaks from between the welding rib 74a and the welded portion 59a, and no toner leaks from between the welding rib 74c and the welded portion 59c, it can be determined that there is no failure in assembly of the toner cartridge 50.

On the other hand, when it is determined that toner (e.g., yellow toner) in the toner storing portion 53a leaks into the toner storing portion 53b from the direction indicated by arrow t1 in FIG. 23A, it can be seen that there is some kind of failure in the sealing member 541a.

When it is determined that toner (e.g., cyan toner) in the toner storing portion 53c leaks into the toner storing portion 53b from the direction indicated by arrow t2 in FIG. 23A, it can be seen that there is some kind of failure in the sealing member 541b.

When it is determined that toner leaks from between the welding rib 74a and the welded portion 59a or between the welding rib 74c and the welded portion 59c, it can be seen that the welding is improper and there is some kind of failure in the welding equipment, parts, or the like.

After it is determined that no toner leaks from the toner storing portions 53a and 53c of the toner cartridge 50 being assembled, as illustrated in FIG. 23A, the cover 70b is moved toward the toner storing portion 53b in the direction indicated by arrow L in the drawing, and the welding rib 74b of the cover 70b and the welded portion 59b of the toner storing portion 53b are fitted together. With the welding rib 74b and the welded portion 59b fitted together, the welding rib 74b is melted by welding, so that the cover 70b is fixed to the frame 50b as illustrated in FIG. 24.

With the cover 70b fixed Lo the frame 50b as illustrated in FIG. 24, the toner storing portion 53b is filled with the corresponding toner (e.g., magenta toner).

At this time, the toner is supplied through the opening 55b illustrated in FIG. 6. It is also possible that the toner storing portion 53b is filled with the corresponding toner before the cover 70b is welded, and then the cover 70b is welded.

After the toner storing portion 53b has been filled with the toner, the toner cartridge 50 is shaken again, and it is visually checked whether toner leaks from the toner storing portion 53b of the toner cartridge 50 being assembled.

When it is determined that no toner leaks from between the welding rib 74b and the welded portion 59b, it can be determined that there is no failure in assembly of the toner cartridge 50.

On the other hand, when it is determined that toner leaks from between the welding rib 74b and the welded portion 59b, it can be seen that the welding is improper and there is some kind of failure in the welding equipment, parts, or the like.

Since, at the stage where the covers 70a and 70c were fixed to the frame 50b as illustrated in FIG. 23A, the sealing members 541a and 541b were determined to have no failure, there is no worry about toner leakages between the toner storing portions 53a and 53b and between the toner storing portions 53c and 53b, and mixture of toners of different colors.

As above, by checking the toner sealability of the sealing members 541a and 541b, and the toner sealability between the welding rib 74a and the welded portion 59a, between the welding rib 74b and the welded portion 59b, and between the welding rib 74c and the welded portion 59c, it is possible to check that there is no toner leakage in the toner cartridge 50.

A toner cartridge of a comparative example will now be described.

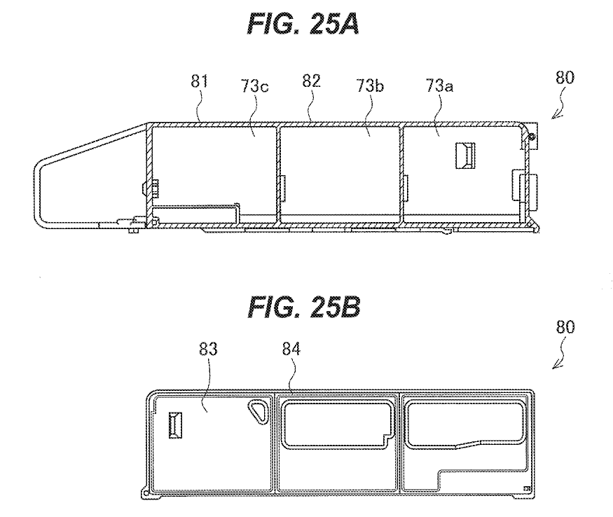

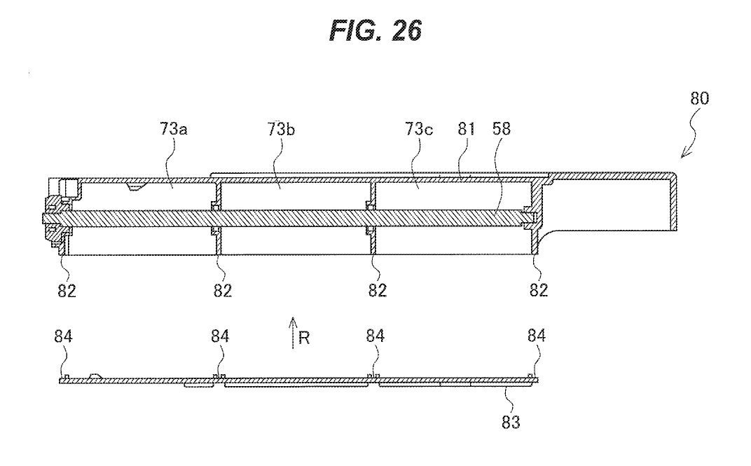

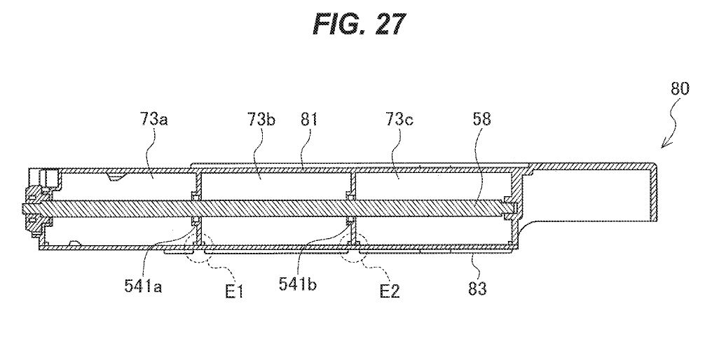

FIGS. 25A and 25B are explanatory views of the toner cartridge 80 of the comparative example. FIG. 25A is a view of the toner cartridge 80 as viewed from the right. FIG. 25B is a view of a cover 83 as viewed from the left. FIG. 26 is a sectional view of the toner cartridge 80 of the comparative example before the cover 83 is attached. FIG. 27 is a sectional view of the toner cartridge 80 of the comparative example after the cover 83 is attached. FIGS. 26 and 27 correspond to FIGS. 22, 23A, 23B, and 24.

As illustrated in FIG. 25A, the toner cartridge 80 of the comparative example includes a frame 81 in which toner storing portions (or toner chambers) 73a, 73b, and 73c are formed. Each of the toner storing portions 73a, 73b, and 73c has an opening. All the openings of the toner storing portions 73a, 73b, and 73c are formed to face to the right. Welded portions 82 indicated by hatching are each formed in a substantially hollow square shape, and are arranged to form rims of the openings of the toner storing portions 73a, 73b, and 73c.

As illustrated in FIG. 25B, the cover 83 is a single body, and has welding ribs 84 formed therein to correspond to the welded portions 82.

The welding ribs 84 of the cover 83 are fitted into the welded portions 82 of the frame 81, and the welding ribs 84 are welded to the welded portions 82, so that the toner cartridge 80 of the comparative example is formed.

As illustrated in FIGS. 26 and 27, the toner cartridge 80 of the comparative example has the same configuration as the toner cartridge of the embodiment except far the frame 81 and cover 83.

As illustrated in FIG. 26, the cover 83 is moved toward the toner storing portions 73a, 73b, and 73c in the direction indicated by arrow R in the drawing, and the welding ribs 84 of the cover 83 and the welded portions 82 of the toner storing portions 73a, 73b, and 73c are fitted together. With the welding ribs 84 and welded portions 82 fitted together, the welding ribs 84 are melted by welding, so that the cover 83 is fixed to the frame 81.

With the cover 83 fixed to the frame 81 as illustrated in FIG. 27, the toner storing portions 73a, 73b, and 73c are filled with corresponding toners.

In the comparative example, even when after the toner storing portions 73a, 73b, and 73c are filled with the toners, the toner cartridge 80 is shaken to check for toner leakage from the toner storing portions 73a, 73b, and 73c of the toner cartridge 80, it is not possible to check for toner leakage due to failure of sealing member 541a or 541b, and toner leakage due to welding failure at a welding part E1 between the toner storing portions 73a and 73b or welding failure at a welding part E2 between the toner storing portions 73b and 73c.

As above, in the comparative example, it is not possible to completely check that no toner leaks from the toner storing portions 73a, 73b, and 73c of the toner cartridge 80. Thus, there is a possibility that a defective toner cartridge in which toner mixture may occur among the toner storing portions 73a, 73b, and 73c is shipped.

When it is tried to check for toner leakage after filling the toner storing portions 73a and 73c with toner, since the opening of the toner storing portion 73b is covered by the cover 83 and the toner storing portion 53b is not exposed, it is not possible to check whether toner leaks from the toner storing portions 73a and 73c into the toner storing portion 73b, and thus it is not possible to determine whether the assembled toner cartridge 80 is defective.

In this embodiment, the covers are separately provided to correspond to the shapes of the openings of the toner storing portions 53a, 53b, and 53c. Thus, it is possible to certainly check that no toner leakage occurs in the toner storing portions of the toner cartridge. Further, it is possible to prevent the covers from being erroneously attached to the toner storing portions 53a, 53b, and 53c.

Further, in this embodiment, as illustrated in FIG. 23A, the openings of the toner storing portions 53a and 53c and the covers 70a and 70c that close the openings are provided on one side (specifically, the right side), and the opening of the toner storing portion 53b adjacent to the toner storing portions 53a and 53c and the cover 70b that closes the opening are provided on another side (specifically, the left side). Thus, it is possible to reduce the length of the toner cartridge 50 in a direction in which the toner storing portions 53a, 53b, and 53c are arranged, thereby downsizing the toner cartridge 50.

This is because it is possible to locate the welding part between the welded portion 59a of the toner storing portion 53a and the cover 70a and the welding part between the welded portion 59c of the toner storing portion 53c and the cover 70c illustrated in FIG. 22 on a side opposite to the side on which the welding part between the welded portion 59b of the toner storing portion 53b and the cover 70b illustrated in FIG. 23A is located, and it is possible to, for example, between the toner storing portions 53a and 53b, reduce the length of the toner cartridge by the length Lo (in the arrangement direction of the toner storing portions 53a, 53b, and 53c illustrated in FIG. 23A) of the welding part, as illustrated in FIG. 23B. Likewise, it is possible to reduce the length of the toner cartridge, between the toner storing portions 53b and 53c.

Also, it is possible to easily provide the length Lo (in the arrangement direction of the toner storing portions 53a, 53b, and 53c illustrated in FIG. 23A) of the welding part illustrated in FIG. 23B. Further, the welded portion 59a illustrated in FIG. 23B can be easily formed. The welded portions 59b and 59c can also be easily formed.

This embodiment has described an example where the openings of the toner storing portions 53a and 53c and the covers 70a and 70c that close the openings are provided on the right side, and the opening of the toner storing portion 53b adjacent to the toner storing portions 53a and 53c and the cover 70b that closes the opening are provided on the left side, which is the opposite side. However, this is not mandatory. The openings of toner storing portions adjacent to each other and the covers that close the openings may be provided on different, but not opposite, sides. For example, the opening of the toner storing portion 53b and the cover 70b that closes the opening may be provided on a side, such as the upper side, other than the left side, which is the opposite side.

By arranging covers for toner storing portions adjacent to each other on different sides, it is possible to reduce a width of a welded portion for welding of the covers, reduce a thickness of the partition between the adjacent toner storing portions, and downsize the toner cartridge without reducing the amount of toner filled in the toner cartridge.

This embodiment has described an example where the toner cartridge 50 includes the three toner storing portions. However, this is not mandatory, and the toner cartridge 50 may include two toner storing portions (e.g., a toner storing portion that stores dark black toner and a toner storing portion that stores light black toner), or may include four or more toner storing portions, such as four toner storing portions that store yellow, magenta, cyan, and black toners, or five toner storing portions that store special color toner (e.g., white toner) in addition to the above toners of the four colors.

As described above, in this embodiment, a cover is separately provided to correspond to an opening of each of toner storing portions of a toner cartridge. This makes it possible to easily check for toner leakage from each toner storing portion.

Further, it is possible to check for toner leakage of a toner cartridge during assembly thereof, thereby finding defects in the toner cartridge during assembly thereof.

Thus, it is possible to prevent erroneous shipment of a toner cartridge that can cause poor color representation due to mixture of toners of different colors.

Covers for toner storing portions adjacent to each other are disposed on different sides. This allows the toner cartridge to be downsized.

In this embodiment, the image forming apparatus has been described as a roll paper printer. However, the image forming apparatus is not limited to this, and may be a printer that prints on precut paper sheets, and may be any image forming apparatus, such as a copier, facsimile machine, multifunction peripheral (MFP), that includes multiple image forming units.

The present invention is not limited to the embodiment described above; it can be practiced in various other aspects without departing from the inventive scope.

What is claimed is:

1. A developer container comprising:
a body in which a plurality of developer chambers that store developer are arranged, each developer chamber having an opening; and
a plurality of covers that seal the openings of the plurality of developer chambers, the plurality of covers being separately provided to correspond to the openings of the plurality of developer chambers.

2. The developer container of claim 1, wherein
the plurality of developer chambers include at least a first developer chamber and a second developer chamber that are arranged adjacent to each other; and
the opening of the first developer chamber and the opening of the second developer chamber are formed on different sides of the body.

3. The developer container of claim 2, wherein the opening of the first developer chamber and the opening of the second developer chamber are formed on opposite sides of the body.

4. The developer container of claim 1, wherein
each opening has an engaged portion;
each cover has a welding portion that engages with the engaged portion of the opening corresponding to the cover; and
each welding portion is welded to the engaged portion corresponding to the welding portion so that each cover seals the opening corresponding to the cover.

5. The developer container of claim 2, wherein
each opening has an engaged portion;
each cover has a welding portion that engages with the engaged portion of the opening corresponding to the cover; and
each welding portion is welded to the engaged portion corresponding to the welding portion so that each cover seals the opening corresponding to the cover.

6. The developer container of claim 3, wherein
each opening has an engaged portion;
each cover has a welding portion that engages with the engaged portion of the opening corresponding to the cover; and
each welding portion is welded to the engaged portion corresponding to the welding portion so that each cover seals the opening corresponding to the cover.

7. The developer container of claim 4, wherein each welding portion is a projection having a substantially isosceles triangular cross-section.

8. The developer container of claim 5, wherein each welding portion is a projection having a substantially isosceles triangular cross-section.

9. The developer container of claim 6, wherein each welding portion is a projection having a substantially isosceles triangular cross-section.

10. The developer container of claim 1, wherein the plurality of developer chambers include at least three developer chambers.

11. The developer container of claim 1, wherein
the openings have different shapes; and
each cover has a shape corresponding to the shape of the opening corresponding to the cover.

12. An image forming unit comprising the developer container of claim 1.

13. An image forming apparatus comprising the developer container of claim 1.
